(19) United States
(12) Patent Application Publication
(10) Pub. No.: US 2006/0145461 A1
(43) Pub. Date: Jul. 6, 2006

(54) Trailer hitch mountable cart

(76) Inventor: Robert B. Anderson, Paradise, CA (US)

Correspondence Address: Richard A. Ryan;Attorney at Law, Suite 110, 8417 N. Millbrook Avenue, Fresno, CA, 93720, US

(21) Appl. No.: 11/027,507

(22) Filed: Dec. 31, 2004

(51) Int. Cl. B60R 9/06

(52) U.S. Cl. 280/769

(57) ABSTRACT

A cart adapted for mounting to a vehicle's trailer hitch assembly allows the user to move materials in the cart to a vehicle, mount the loaded cart on the vehicle and transport it to a location where the cart can be used to unload the materials. The cart comprises a tubular hitch member defining a receiver tube at one end and a tow hitch receiver at the opposite end. A connecting member interconnects the receiver tube to the vehicle's tow hitch receiver and supports the cart on the vehicle. A hitch bar having a towing ball is inserted into the cart's tow hitch receiver to tow a trailer behind the vehicle. A jack assembly having a jack and a jack base with a plurality of rotatable and pivotal wheels is used to raise and lower the cart and move the cart into alignment with the vehicle's tow hitch receiver.

### CROSS-REFERENCE TO RELATED APPLICATIONS

None.

### BACKGROUND OF THE INVENTION

A. Field of the Invention

The field of the present invention relates generally to carts, including wagons, tool boxes and platforms, that are configured to be removably mounted to and carried by a trailer hitch assembly attached to a vehicle. More particularly, the present invention relates to such trailer hitch mountable carts having a lifting mechanism to raise and lower the cart to the vehicle's trailer hitch assembly. Even more particularly the present invention relates to such trailer hitch mountable carts that include a rearward facing tow hitch receiver for towing another object, such as a camping trailer or trailer mounted boat, behind the cart mounted on the vehicle.

B. Background

Many people utilize relatively small carts, wagons, enclosed boxes or wheeled platforms, collectively these are hereinafter referred to as “carts,” to move heavy and/or bulky items from one place to another. Often, it is useful to load a cart with materials, move the loaded cart to an automobile, truck, recreational vehicle, trailer, boat or other vehicle and then unload the materials from the cart into the vehicle for transport to a more distance place, such as a campsite, jobsite or other places. For instance, many people enjoy going camping or other outdoor activities that typically require a number of different items, such as tents, stoves, chairs, fuel, shovels and the like, that can be conveniently carried to the vehicle by a cart and then transported to the camping or other outdoor location. As many people know, it is often convenient, desirable or even necessary to utilize the cart to move or store the materials at the remote location when unloading the materials from the vehicle. For instance, with the camping example referenced above, it is generally desirable to use the cart to move the camping equipment from the vehicle, which may be in a remote parking area, to the actual campsite. Utilizing a cart reduces the amount of time and effort required to get the camping equipment to the campsite, thereby enhancing the person's enjoyment of the camping experience. When it is time to leave, the camping equipment can be loaded back into the cart and hauled to the vehicle. For certain materials, such as work tools, it is desirable to use the cart to move the tools from the vehicle to the jobsite and store the tools in the cart until actually needed for the work activity.

The need to utilize the cart at the remote location creates two primary difficulties, namely lifting the cart into the vehicle and fitting the cart inside most vehicles. Even if the time and effort is taken to unload the materials from the cart to the vehicle prior to loading the cart in the vehicle, most carts of any size and/or substance are not of insignificant weight. In addition, because the typical cart comprises a cart body having a plurality of wheels attached thereto and a tow handle at one end for pulling the cart, many people have trouble lifting and moving the cart into a vehicle. If a cart is large enough to carry much materials, which is generally more desirable, it will not fit inside most automobiles and will even have trouble fitting into many of the larger sized vehicles, such as trucks and sport utility vehicles. Although many carts could fit inside the bed of a pickup truck, the interior of a recreational vehicle or inside other large vehicles, the cart must then be secured to limit movement of the cart while driving so as to prevent damage to the cart, materials inside the cart and/or the vehicle. Another common problem with carrying a cart inside a vehicle is that very often the cart's wheels are dirty from being pulled through grass, dirt, mud or even road-based grease or other contaminants. The materials inside the cart can also be wet, muddy or otherwise in a condition that make it undesirable to carry the materials inside the vehicle, whether loaded in the cart or unloaded from the cart.

A number of different solutions to the above problem exist. One such solution is to utilize a small trailer or trailer-type apparatus that attaches to the vehicle's trailer hitch to carry materials from one location to another. These types of apparatuses, however, are generally too large, heavy and difficult to maneuver for the typical person to utilize as a convenient cart to carry materials from and to a vehicle and other locations (i.e., campsites and jobsites). In addition, many people are not comfortable with pulling a trailer behind a vehicle. Some people utilize cargo carriers or tool boxes that are or can be removably attached to the top of the vehicle or inside the vehicle's bed compartment, such as the bed of a pickup truck. These cargo carriers and tool boxes are generally configured to merely receive the materials at the vehicle and are not suited for carrying materials back and forth to the vehicle in the cargo carrier or tool box.

A number of patents describe carts that attach to a trailer hitch and/or describe trailer hitch mechanisms that are suitable for supporting and carrying a cart on a trailer hitch. For instance, U.S. Pat. No. 6,612,615 to Dimand discloses a trailer hitch cart attachment mechanism that includes a cart adapter having outwardly extending lateral bars that are configured to be received by a pair of socket tubes on a cart and a jack housing that houses a jack for raising and lowering a slidable member attached to the cart adapter for raising/lowering the cart off the ground. U.S. Patent Application Publication No. 2002/0180179 to Kraus discloses a transportable storage container assembly that has a trailer with a hitch assembly at its forward end to attach to the vehicle's hitch and a wheel unit at the rearward end to support the trailer off the ground and roll the trailer with the vehicle. A jack under the trailer is used to pivot the trailer's hitch assembly for engaging or disengaging from the trailer from the vehicle. When disengaged, the jack is retracted and the rearward wheel is folded upward to allow the trailer to be moved on its own wheels. U.S. Pat. No. 4,744,590 to Chesney discloses a removably attached suspended trailer apparatus that, in FIG. 2, includes retractable supports having wheels at the lower end that can be lowered to support the apparatus and allow it to be rolled for loading and unloading. U.S. Pat. No. 4,593,840 to Chown discloses a load carrying unit comprising a small trailer-like container that has wheels at the bottom of legs to roll the container into place on the vehicle's hitch ball. Once in place, the legs/wheels are retracted off the ground and the container component is slid forward to reduce the cantilever stress on the system. U.S. Pat. Nos. 5,620,126; 5,732,866; 5,788,135; 6,168,058 and 6,471,104 to Janek disclose a cargo carrier having a tubular frame that connects to the vehicle's trailer hitch and frame to support a tub-like container off the ground. The tub can be removed from the tubular frame for loading/unloading materials therefrom. While the foregoing discloses various types of cart carrying apparatuses, limitations with these apparatuses have apparently limited their wide acceptance. For instance, several of the apparatuses do not provide a mechanism for easily placing the cart onto the support mechanism or vehicle trailer hitch. As such, the user is required to pick up and/or drag the cart across the ground to get the apparatus into proper alignment for raising the cart off the ground. Yet others have cart components that are either difficult to move or have limited free movement away from the vehicle trailer hitch. Yet others have limited capability for use as a cart/wagon to haul a significant amount of materials. Another problem with the foregoing apparatuses is that their use forecloses use of the vehicle to tow a trailer or other object (i.e., the capability shown in conjunction with the two wheel vehicle carrier described in U.S. Pat. No. 5,579,973 to Taft).

What is needed, therefore, is an improved cart that is configured for mounting to and being carried by a vehicle's trailer hitch. The preferred trailer hitch mountable cart should be completely functional as a useful cart when dismounted from the trailer hitch, be capable of being raised to and lowered from the vehicle's trailer hitch and be easy to align with the trailer hitch so as to securely mount the cart thereto. The preferred trailer hitch mountable cart should incorporate a mounting system that is relatively inexpensive to manufacture and easy for the average person to utilize. The preferred trailer hitch mountable cart should be adaptable to a variety of different sizes and configurations of carts. In addition, the preferred trailer hitch mountable cart should be configured with a rearward facing tow hitch receiver, preferably of standard configuration, that allows the user to tow a trailer or other object behind the vehicle to which the trailer hitch mountable cart is mounted.

### SUMMARY OF THE INVENTION

The trailer hitch mountable cart of the present invention solves the problems and provides the benefits identified above. That is to say, the present invention discloses a new and improved trailer hitch mountable cart that is adaptable to wide variety of different sizes and configurations of carts, wagons, enclosed boxes, wheeled platforms and other cart or cart-like apparatuses that are fully functional for their intended carrying purposes when dismounted from the vehicle's trailer hitch. The trailer hitch mountable cart of the present invention is relatively easy to raise to and lower from the vehicle trailer hitch and properly align the cart therewith for secure attachment to the vehicle trailer hitch. In at least one embodiment of the present invention, the mounting system component uses generally standard components that results in a relatively inexpensive mounting system whose use is relatively familiar to most people. The trailer hitch mountable cart of the present invention can include a rearward facing tow hitch receiver that is utilized to tow a trailer or other object. The trailer hitch mountable cart can be utilized with a cart-like apparatus (i.e., a wagon) to move and transport camping equipment, wood, sporting equipment and many other objects. In addition, the cart can be configured to move and transport two, three or four-wheeled vehicles, such as a mobility scooter, motorcycle or other objects.

In one general aspect of the present invention, the trailer hitch mountable cart of the present invention includes a cart bottom having a first side, a second side and a bottom surface disposed therebetween with an elongated hitch member attached to the cart bottom. The hitch member has a first end generally toward the first side of the cart bottom and a second end generally toward the second side of the cart bottom. In the preferred embodiment, the first end of the hitch member defines a receiver tube that is sized and configured to receive the second end of a connecting member that interconnects the receiver tube to the vehicle's tow hitch receiver. The first end of the connecting member is sized and configured to be received by the vehicle tow hitch receiver. The connecting member is configured to support the cart on the trailer hitch assembly when the connecting member interconnects the cart's hitch member and the vehicle's tow hitch receiver. One or more hitch pins can be utilized to join the connecting member to the vehicle's tow hitch receiver and the hitch member. A jack assembly is attached to either the cart bottom or, preferably, the hitch member. The jack assembly has a jack and a jack base attached to the jack and is operatively configured to raise and lower the jack base relative to the cart bottom. In the preferred embodiment, the jack base has a plurality of wheels that are rotatably and pivotally attached thereto. The jack assembly is configured to support the cart above the ground or other surface and allow movement of the cart on the plurality of wheels across the surface. In the preferred embodiment, the trailer hitch mountable cart has a second tow hitch receiver attached to the cart bottom at or near the second side of the cart bottom so the user can attach a trailer or other object thereto and tow behind the cart mounted on the vehicle. Preferably, the second end of the hitch member defines the second tow hitch receiver, which is sized and configured to receive a standard hitch bar having a towing ball disposed thereon. In alternative embodiments, various components, such as the connecting member and hitch member and/or the hitch member and the hitch bar, can be fixedly attached or made integral with each other to reduce the number of necessary connections. In use, the user loads the cart with the desired materials and rolls the cart to the vehicle on the carts own wheels. Once near the vehicle, the user operates the jack to lower the jack base and raise the cart off of the ground or other surface so that he or she can maneuver the cart, using the wheels on the jack base, into proper alignment with the vehicle's tow hitch receiver to mount the cart thereto. To dismount the cart from the vehicle, the user operates the jack to lower the jack base wheels to the ground and transfer the cart's weight to the jack assembly. The cart is disconnected from the vehicle tow hitch receiver and then the jack is operated to lower the cart and transfer the weight to the cart's wheels. The user then can move the cart to where he or she wants the materials. The cart of the present invention allows the user to move and transport materials without having to load the materials in and out of the cart and the vehicle, and without having to load and unload the cart from inside the vehicle, thereby substantially reducing time and effort to move such materials.

Accordingly, the primary objective of the present invention is to provide a trailer hitch mountable cart that provides the advantages discussed above and that overcomes the disadvantages and limitations associated with presently available trailer hitch mountable carts.

It is also an object of the present invention to provide a trailer hitch mountable cart that is adaptable to a wide variety of different sizes and configurations of carts and which is relatively easy to raise to, lower from and align with a vehicle's tow hitch receiver.

It is also an object of the present invention to provide a trailer hitch mountable cart that incorporates a cart or cart-like apparatus that is fully functional for its intended purpose when dismounted from the vehicle's trailer hitch.

It is also an object of the present invention to provide a trailer hitch mountable cart that incorporates a rearward facing tow hitch receiver to allow the user to tow a trailer or other object behind the trailer hitch mountable cart of the present invention.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a rear view of a trailer hitch mountable cart configured according to a preferred embodiment of the present invention shown attached to a vehicle's trailer hitch assembly;

FIG. 2 is a side view of the trailer hitch mountable cart configured as shown in FIG. 1;

FIG. 3 is an isolated side view of the trailer hitch assembly components useable with the trailer hitch mountable cart of the present invention to attach to a vehicle's tow hitch receiver and to provide a rearward facing tow hitch receiver;

FIG. 4 is a rear view of the trailer hitch mountable cart of the present invention configured with an alternatively configured cart (i.e., a tool box);

FIG. 5 is a rear view of the trailer hitch mountable cart of the present invention configured with an alternatively configured cart (i.e., a platform for supporting a mobility scooter);

FIG. 6 is an isolated side view of the trailer hitch mountable cart of the present invention showing an alternative embodiment of the hitch member and connecting member (the cart's wheels and jack assembly not being shown thereon);

FIG. 7 is an isolated side view of the trailer hitch mountable cart of the present invention showing another alternative embodiment of the hitch member, connecting member and hitch bar (the cart's wheels and jack assembly not being shown thereon); and

FIG. 8 is a rear view of the trailer hitch mountable cart of the present invention configured with the alternatively configured cart of FIG. 4 and utilizing a plurality of jacks, one at each corner of the cart.

### DETAILED DESCRIPTION OF THE PREFERRED EMBODIMENTS

With reference to the figures where like elements have been given like numerical designations to facilitate the reader's understanding of the present invention, and particularly with reference to the embodiments of the trailer hitch mountable cart of the present invention illustrated in the figures, various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

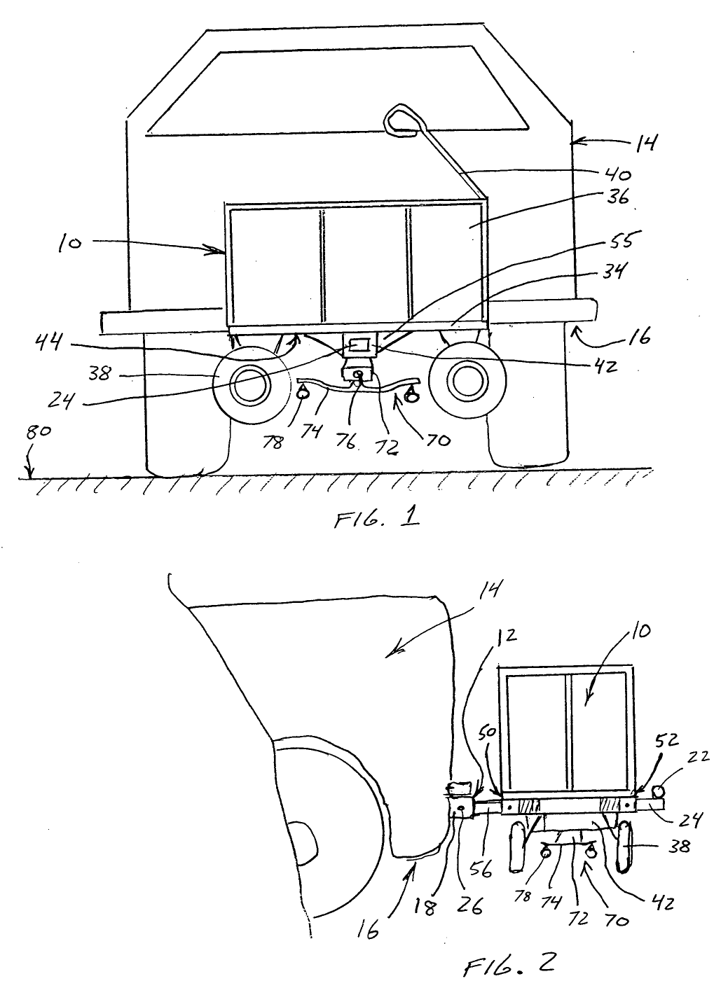

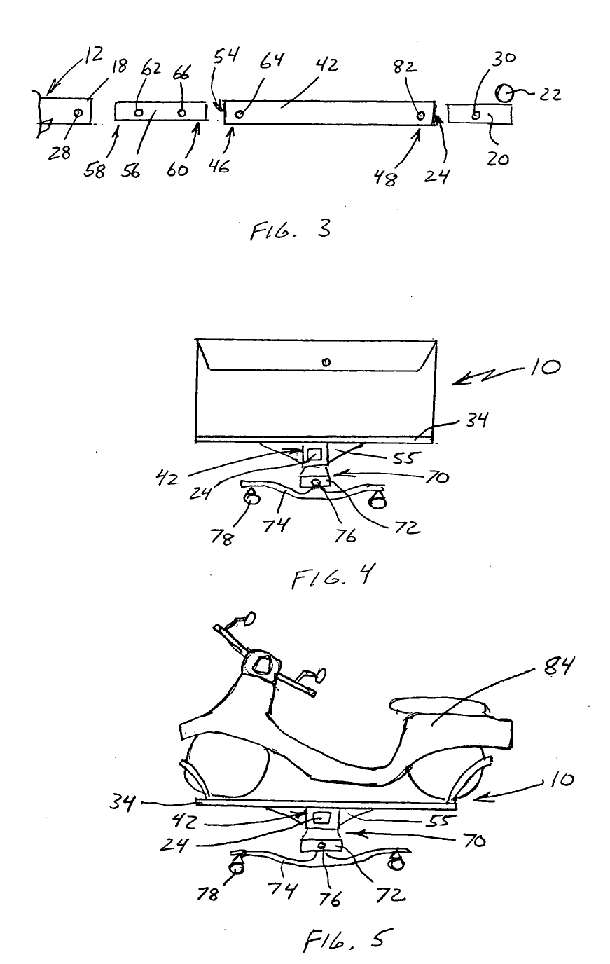

In the preferred embodiment of the trailer hitch mountable cart of the present invention, shown in the figures, the trailer hitch mountable cart is identified generally as 10. FIGS. 1 and 2 included herewith show a preferred embodiment of trailer hitch mountable cart 10 mounted on trailer hitch assembly 12 of vehicle 14. As discussed generally above, cart 10 is configured for use as a standard cart, wagon, tool box, wheeled platform or other cart-like apparatus that can be loaded with a variety of different materials or objects and utilized to move those materials or objects as desired, including to the rear of vehicle 14 so as to be mounted on trailer hitch assembly 12 thereof. As best shown in FIG. 2, the typical trailer hitch assembly 12 is fixedly attached at the rear 16 of vehicle 14 and includes a tubular female tow hitch receiver 18 having an opening (not shown) which faces rearward from vehicle 14. As known in to those skilled in the art, tow hitch receiver 18 is generally a square or near square tube that is configured to receive a cooperatively sized and configured hitch bar 20 having a towing ball 22 fixedly mounted thereon, as shown in FIG. 3 for connection to a trailer or other towable object (as explained below in use with cart 10 of the present invention, hitch bar 20 and towing ball 22 are received by a second tow hitch receiver 24 mounted to cart 10). In use without cart 10, hitch bar 20 is inserted into tow hitch receiver 18 and then secured in place by one or more hitch pins 26 that are received through cooperatively configured hole 28 on tow hitch receiver 18 and hole 30 on hitch bar 20. Typically, motor vehicle laws or codes require the use of a safety chain 32 when connecting any object, such as cart 10 or a standard trailer, to a trailer hitch assembly 12 as a backup to failure of hitch pin 26.

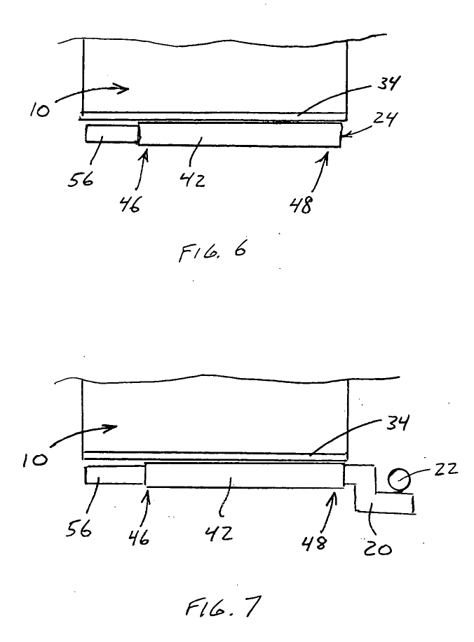

Cart 10 can be of the type that is configured like a wagon, as shown in FIGS. 1 and 2, the tool box or other enclosed box shown in FIG. 4, the wheeled platform configured to carry two or more wheeled vehicles shown in FIG. 5 or a variety of different types of carts or cart-like apparatuses. In a preferred embodiment, cart 10 is a wagon type of cart that has a cart bottom 34 with a plurality of upstanding sides 36 around cart bottom 34 and wheels 38 rotatably attached to cart bottom 34 or a chassis assembly (not shown) thereunder. Typically, a pull handle 40 is attached to cart 10 to allow the user to pull cart 10 from one place to another. Sides 36 of cart 10 can be configured to be fixed in the upstanding position or can be of the type wherein one or more of sides 36 fold down or are removable to facilitate emptying of materials from cart 10. Although not shown, cart 10 can have a fixed or removable top portion that covers or encloses the materials in cart 10 during storage and/or transport. As known to those skilled in the art, the typical cart 10 has wheels 38 which are configured to move in a forward, rearward or curved direction, but generally not in a sideways direction. To move cart 10 sideways, the user has to either push or pull cart 10 to get it to slide sideways or has to maneuver cart 10 forward and backward until it is in the desired position. This difficulty with moving a typical cart is one of the limitations of the prior art trailer hitch mountable systems that makes it difficult for the user to align the typical cart with the opening in tow hitch receiver 18.

To connect cart 10 to trailer hitch assembly of vehicle 14 so that it may be carried by vehicle 14 as desired, the preferred embodiment of cart 10 includes a cart hitch member 42 that is fixedly attached to the bottom surface 44 of cart 10 (i.e., under cart bottom 34). As best shown in FIGS. 2 and 3, hitch member 42 is a tubular member having first end 46 and second end 48 that extends from first side 50 of cart bottom 34 to second side 52 of cart bottom 34 and defines a receiver tube 54 at first end 46 and a second tow hitch receiver 24 at second end 48. Depending on the materials utilized for cart bottom 34 and hitch member 42, hitch member 42 can be welded, bolted, glued or otherwise fixedly attached to the lower side 44 of cart 10 at cart bottom 34. The mechanism chosen to attach hitch member 42 to cart bottom 34 should be selected based on the ability to withstand the loads and stresses involved with carrying cart 10 on vehicle 14. Although shown as a single member in the preferred embodiment, hitch member 42 can be two separate pieces that are both attached to cart bottom 34 and provide the desired receiver tube 54 at first side 50 and second tow hitch receiver 24 at second side 52. In the preferred embodiment, first end 46 and second end 48 of hitch member 42 are either aligned with first side 50 and second side 52, respectively, positioned such that they do not extend past the vertical plane formed by sides 50 and 52 (i.e., set back from sides 50 and 52) or only extend a relatively small amount past the vertical plane formed by sides 50 and 52 so they do not hinder or in any way detract from the use of cart 10 separate from vehicle 14. As generally familiar to most persons, if ends 46 and/or 48 do extend past sides 46 and/or 48, then they could be in the way during use of cart 10 or cause injury to persons or damage to other objects. If desired or necessary, a pair of brace members 55, shown in FIG. 1, at bottom surface 44 of cart 10 can be utilized to provide additional support to hitch member 42.

In the preferred embodiment of the present invention, a connecting member 56 having a first end 58 and a second end 60 is utilized to connect hitch member 42, and therefore cart 10, to trailer hitch assembly 12. First end 58 of connecting member 56 is sized and configured to be received in tow hitch receiver 18 and second end 60 of connecting member 56 is sized and configured to be received in receiver tube 54. The preferred mechanism to connect first end 58 of connecting member 56 to tow hitch receiver 18 is a standard hitch pin 26, such as those used with the typical non-cart hitch assembly 12, that is inserted through hole 28 in hitch assembly 12 and a corresponding hole 62 towards first end 58 of connecting member 56. The preferred mechanism to connect second end 60 of connecting member 56 to receiver tube 54 of hitch member 42, which is attached to cart 10, is also standard hitch pin 26 that is inserted through hole 64 near first end 46 of hitch member 42 and a corresponding hole 66 towards second end 60 of connecting member 56. In the preferred embodiment, a substantial amount of connecting member 56 is received in tow hitch receiver 18 and receiver tube 54 to support cart 10 on trailer hitch assembly 12. As known to those skilled in the art, depending on the materials chosen for the various components described herein, it is necessary to account for the cantilever effect of cart 10 on trailer hitch assembly 12 to avoid failure of hitch member 42 and/or connecting member 56. Generally, it may be necessary to have a weight limit associated with cart 10 and the materials carried thereby and/or the trailer towed behind to avoid damage to cart 10, the materials and/or hitch assembly 12. With the above described configuration, or an equivalent configuration, cart 10 is carried behind vehicle 14 on trailer hitch assembly 12 such that the user can move cart 10 and any materials carried therein from one location to another, such as from the home to a campsite or from the office to a jobsite, as needed or desired.

Generally, it will be preferred to have to hitch receiver 18, receiver tube 54 and second tow hitch receiver 24 configured alike so as to allow either end 58 or 60 of connecting member 56 to be received into tow hitch receiver 18 or receiver tube 54 and to allow the same hitch bar 20 to fit into both tow hitch receiver 18 and second tow hitch receiver 24. Alternatively, it may be desirable to configure the ends 58 and 60 of connecting member 56 differently such that only first end 58 can fit into tow hitch receiver 18 and only second end 60 can fit into receiver tube 54. Likewise, under certain circumstances, it may be desirable to configure first tow hitch receiver 18 differently from second tow hitch receiver 24 to require different sized or configured hitch bars 20 to be used at first tow hitch receiver 18 and second tow hitch receiver 24.

The vast majority of carts 10 are configured such that, in their normal use as a cart, receiver tube 54 will be positioned lower than tow hitch receiver 18. To avoid having to lift cart 10 up to mount to trailer hitch assembly 12 or down to remove cart 10 from trailer hitch assembly 12, cart 10 of the present invention is provided with a jack assembly 70, as best shown in FIGS. 1 and 2, to raise/lower cart 10 to/from tow hitch receiver 18 and to align receiver tube 54 with tow hitch receiver 18. To raise and lower cart 10, jack assembly 70 preferably comprises a jack 72, such as a scissor jack, screw jack or other type of jack, that is disposed between hitch member 42 and a jack base 74 to raise and lower jack base 74 relative to hitch member 42. In the preferred embodiment, one part of jack 72 is fixedly attached to hitch member 42 and the other part is fixedly attached to jack base 74 to displace jack base 74 up or down relative to cart bottom 34. Because the typical materials utilized for cart bottom 34, hitch member 42, jack 72 and jack base 74 will be metal, these components can be joined together by welding or other appropriate mechanism. As familiar to those skilled in the art, jack 72 has a jack operation mechanism 76, shown in FIG. 1, that allows the user of jack 72 to operate jack 72 to raise or lower jack base 74. Jack assembly 70 should be configured such that jack operation mechanism 76 is relatively easy for the user to access so that he or she can raise jack base 74, and therefore cart 10, as desired. For ease of use, jack operation mechanism 76 should also be selected to be relatively easy for the user to operate. If desired, an electric or hydraulic actuated jack system can be utilized for jack 72.

Also in the preferred embodiment, jack base 74 has a plurality of wheels 78 attached thereto to support jack base 74 and cart 10 off the ground surface 80 and allow the user to move cart 10 around as desired to align first end 58 of connecting member 56 with tow hitch receiver 18 or align receiver tube 54 with second end 60 of connecting member 56, depending on which order the user connects the components of cart 10 to vehicle 14, as discussed in more detail below. Operating jack 72 to lower jack base 74 until wheels 78 touch the surface 80 below cart 10 allows the user to raise cart 10 so as to vertically align receiver tube 54 with tow hitch receiver 18 or lower wheels 38 of cart 10 to surface 80 and shift the weight of cart 10 between trailer hitch assembly 12 and jack assembly 70 so that the user can move cart 10 towards or away from tow hitch receiver 18 and vehicle 14. The components of jack assembly 70 must be sized, configured and of sufficient strength to adequately and safely support the anticipated weight of a fully loaded cart 10 and balance cart 10 so that the user can move cart 10 on wheels 78 when wheels 38 of cart 10 are displaced above surface 80 while attaching cart 10 to or removing cart 10 from tow hitch receiver 18 without danger of tipping cart 10 over. In the preferred embodiment of the present invention, cart 10 solves the aforementioned alignment problem by incorporating wheels 78 that are both rotatably and pivotally attached to jack base 74. Selecting wheels 78 that rotate allows the user to move cart 10 forward and backward as desired. Pivoting wheels 78, such as used as castors on many types of furniture or platform dollies, also allows the user to move cart 10 sideways as necessary to mount cart 10 to trailer hitch assembly 12. This ability to easily align cart 10 with trailer hitch assembly 12 provides a much more effective and useful trailer hitch cart assembly relative to the prior art assemblies.

In use, the user loads cart 10 with the materials that he or she wants to move from one location to another (i.e., the home to a campsite) via a vehicle 14 having a trailer hitch assembly 12. Once cart 10 is loaded, the user pulls on handle 40 to move cart 10 behind vehicle 14. To load cart 10 on the vehicle's tow hitch receiver 18, the user operates jack operation mechanism 76 to cause jack 72 to lower jack base 74, having wheels 78 attached thereto, to surface 80. Once wheels 78 contact surface 80, further operation of jack 72 causes cart 10 to raise such that wheels 38 of cart 10 will be displaced above surface 80. With connecting member 56 placed inside either tow hitch receiver 18 or tube receiver 54, the user moves cart 10 on wheels 78 closer trailer hitch assembly 12. Depending on the alignment, the user raises or lowers cart 10 using jack 72 or moves cart 10 on wheels 78. Once aligned, the user pushes cart 10 toward trailer hitch assembly 12. In one method of operation, the user first places connecting member 56 inside receiver tube 54 of hitch member 42, secures connecting member 56 in place with hitch pin 26 through holes 66 and 64, guides cart 10 such that the outwardly extending portion of connecting member 56 is inserted into the open tow hitch receiver 18 and then secures connecting member 56 in tow hitch receiver 18 with hitch pin 26 through holes 28 and 62. In an alternative method of operation, the user first places connecting member 56 inside tow hitch receiver 18, secures connecting member 56 in place with hitch pin 26 through holes 28 and 62, guides cart 10 such that the open receiver tube 54 is guided toward the outwardly extending portion of connecting member 56 to insert connecting member into receiver tube 54 and then secures connecting member 56 in receiver tube 54 with a hitch pin 26 through holes 64 and 66. Once cart 10 is secured to trailer hitch assembly 12 of vehicle 14, the user operates jack operation mechanism to retract jack 72 and raise jack base 74 and wheels 78 off of surface 80. Jack base 74 and wheels 78 should be raised a sufficient amount such that they will not contact the ground 80 or any other objects while driving vehicle 14. The user then can drive vehicle 14 to the desired location and remove cart 10 from trailer hitch assembly 12 by lowering jack base 74 and wheels 78 to surface 80, disengaging connecting member 56 from tow hitch receiver 18 and receiver tube 54, pushing cart 10 away from vehicle 14 on wheels 78, retracting jack 72 to lower wheels 38 to the ground, continuing to retract jack 72 to raise jack base 74 and wheels 78 to just under cart bottom 34 and then pulling cart 10 by handle 40 to move the materials in cart 10 on wheels 38 to the desired location, where the materials in cart 10 can be unloaded (if desired). When the user is ready to leave, he or she merely repeats the above process. If the user desires to tow a trailer or the like behind vehicle 14, he or she merely inserts hitch bar 20, having towing ball 22, into second tow hitch receiver 24 and inserts hitch pin through hole 82 in hitch member 42 and hole 30 in hitch bar 20. Generally, the user will remove hitch bar 20 from second tow hitch receiver 24 prior to utilizing cart 10 on wheels 38 to avoid contact problems with hitch bar 20 and towing ball 20 extending outwardly from second side 52 of cart 10.

In the embodiment shown in FIG. 4, cart 10 is a closeable, lockable toolbox having wheels 38, hitch member 42 and jack assembly 70 attached to the bottom 34 thereof so the user can transport it to a jobsite or other location on trailer hitch assembly 12 of vehicle 14. If desired, the toolbox/cart 10 can include pull handle 40 shown in FIG. 1 or be configured with a pair of handles (not shown) on a pair of opposing sides 36, as with conventional tool boxes. The basic components and function of this embodiment is the same as described above. In the embodiment shown in FIG. 5, cart 10 is a wheeled platform for carrying a relatively small two, three or four wheeled vehicle, such as the mobility scooter 84 shown. Other than including a mechanism for securing mobility scooter 84 to wheeled platform/cart 10, the components and their operation are the same as those described in the embodiments set forth above. In this configuration, the user can store mobility scooter 84 on wheeled platform/cart 10 when not in use, move it on wheels 38 from the storage location to vehicle 14, and then use jack assembly 70 to raise/lower mobility scooter 84 to/from the vehicle's trailer hitch assembly 12 so as to transport mobility scooter 84 to the store, park or other location where its use is desired or needed without having to load it inside vehicle 14.

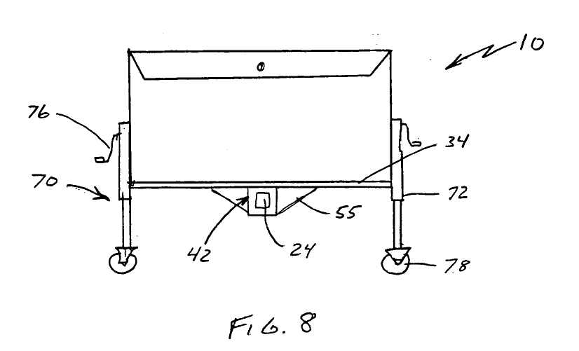

In an alternative embodiment of cart 10 of the present invention, shown in FIG. 6, connecting member 56 is fixedly attached to or integral with hitch member 42 under cart 10. As described above, second end 48 of hitch member 43 defines the second tow hitch receiver 24. Preferably, first end 58 of connecting member 56 does not extend past first side 50 of cart bottom 34. An advantage of this embodiment is that there is no receiver tube 54 and no need for a hitch pin 26 to connect connecting member 56 to hitch member 42, which will reduce the cost of making cart 10 and result in less connections for the use of cart 10. The primary disadvantage of having first end 58 of connecting member 56 extending outwardly from the first side 50 of cart bottom 34 is that this can be a danger (i.e., hitting someone or tripping over it) from or inconvenience to the use of cart 10 away from vehicle 14. This danger is substantially reduced or eliminated by setting the first end of connecting member 56 back under cart 10 so it does not extend past first side 50 of cart bottom 34 (as shown in FIG. 6). Sufficient room between cart 10 and vehicle 14 must be provided to prevent contact while transporting cart 10 on trailer hitch assembly 12. In the alternative embodiment shown in FIG. 7, hitch bar 20 (having towing ball 22 thereon) is fixedly attached or integral with second end 48 of hitch member 42, thereby reducing the need for hitch pin 26 to join hitch bar 20 to hitch member 42. If desired, hitch member 42 can be configured such that hitch bar is primarily or entirely under cart bottom 34 so it is not a danger or inconvenience to the use of cart 10 away from vehicle 14.

In another alternative embodiment jack assembly 70 can be configured such that it is mounted directly to the lower side 44 of cart 10 instead of to hitch member 42 as shown in the figures. This may be a preferred method if second tow hitch receiver 24 is eliminated from cart 10 of the present invention. In such an embodiment, hitch member 42 only provides receiver tube 54 for connecting to tow hitch receiver 18. Jack assembly 70 can be attached to cart bottom 34 either behind or along side hitch member 42. In either configuration, proper bracing may be required to adequately and properly support cart 10 when it is being moved on wheels 78 of jack base 74.

In yet another embodiment, shown in FIG. 8, jack assembly 70 comprises a plurality of jacks 72 attached to cart bottom 34 to raise or lower cart bottom 34, shown in use with the tool box of FIG. 4, to tow hitch receiver 18. In the preferred configuration of this embodiment, four jacks 72 are utilized, one at each corner of cart bottom 34. The jacks 72 can be of the type commonly referred to as swivel trailer jacks that each have a jack operation mechanism 76, such as the rotating handle, to raise and lower wheel 78. Generally, these jacks 72 utilize a pull pin and/or locking lever to secure jack 72 in either its raised or lowered position. As shown in FIG. 8, hitch member 42 is preferably configured with second tow hitch receiver 24 to receive hitch bar 20 to allow the user to tow another object behind cart 10. Jacks 72 can attach to the sides 36 or lower side 44 of cart bottom 34. If cart bottom 34 is integral with the tool box or other item to be raised and lowered to tow hitch receiver 18, then the plurality of jacks 72 can be affixed to the sides of the tool box or other item. To raise or lower cart bottom 34 so that it can be mounted on or removed from tow hitch receiver 18, the user operates jack operation mechanism, shown as a typical hand-crank type of device, to extend or retract a portion of jack 72. The basic components and function of this embodiment is the same as described above.

While there are shown and described herein certain specific alternative forms of the invention, it will be readily apparent to those skilled in the art that the invention is not so limited, but is susceptible to various modifications and rearrangements in design and materials without departing from the spirit and scope of the present invention. In particular, it should be noted that the present invention is subject to modification with regard to assembly, materials, size, shape and use. For instance, some of the components described above can be made integral with each other to reduce the number of separate components and various replacement components can be utilized that perform the same function as those described above.

What is claimed is:

1. A trailer hitch mountable cart for use with a vehicle having a trailer hitch assembly with a first tow hitch receiver, said cart comprising:
a cart bottom having a first side, a second side and a bottom surface disposed between said first side and said second side;
a hitch member attached to said cart bottom, said hitch member having a first end and a second end, said first end of said hitch member generally toward said first side of said cart bottom and said second end of said hitch member generally toward said second side of said cart bottom, said first end of said hitch member defining a receiver tube;
a connecting member sized and configured to interconnect said receiver tube to said first tow hitch receiver and support said cart on said trailer hitch assembly; and
a jack assembly attached to either of said hitch member or said cart bottom, said jack assembly having a jack and a jack base attached to said jack, said jack operatively configured to raise and lower said jack base relative to said cart bottom, said jack base having a plurality of wheels attached thereto, said jack assembly configured to support said cart above a surface and allow movement of said cart on said plurality of wheels across said surface.

2. The trailer hitch mountable cart according to claim 1, wherein said connecting member has a first end and a second end, said first end of said connecting member sized and configured to be received in said first tow hitch receiver, said second end sized and configured to be received in said receiver tube.

3. The trailer hitch mountable cart according to claim 2, wherein said first tow hitch receiver and said connecting member are releasably joined by a hitch pin disposed through a first hole in said first tow hitch receiver and a second hole in said connecting member.

4. The trailer hitch mountable cart according to claim 1 further comprising a second tow hitch receiver attached to said cart bottom at or near said second side of said cart bottom.

5. The trailer hitch mountable cart according to claim 1, wherein said cart has one or more wheels rotatably attached thereto.

6. The trailer hitch mountable cart according to claim 1, wherein said hitch member is tubular and extends from at or near said first side of said cart bottom to at or near said second side of said cart bottom, said second end of said hitch member defining a second tow hitch receiver, said second tow hitch receiver sized and configured to receive a hitch bar.

7. The trailer hitch mountable cart according to claim 1, wherein said plurality of wheels on said jack base are rotatably and pivotally attached to said jack base.

8. The trailer hitch mountable cart according to claim 1, wherein said hitch member does not extend beyond said sides of said cart bottom.

9. The trailer hitch mountable cart according to claim 1, wherein said connecting member is integral with said first end of said hitch member.

10. The trailer hitch mountable cart according to claim 9 further comprising a second tow hitch receiver at said second end of said hitch member.

11. The trailer hitch mountable cart according to claim 9, wherein said second end of said hitch member is integral with a hitch bar having a towing ball disposed thereon.

12. The trailer hitch mountable cart according to claim 9, wherein said connecting member does not extend beyond said first side of said platform bottom.

13. A trailer hitch mountable cart for use with a vehicle having a trailer hitch assembly with a first tow hitch receiver, said cart comprising:
a cart bottom having a first side, a second side and a bottom surface disposed between said first side and said second side;
a hitch member attached to said cart bottom, said hitch member having a first end and a second end, said first end of said hitch member generally toward said first side of said cart bottom and said second end of said hitch member generally toward said second side of said cart bottom, said first end of said hitch member defining a receiver tube;
a connecting member having a first end and a second end, said first end of said connecting member received in said first tow hitch receiver and said second end received in said receiver tube so as to interconnect said receiver tube to said first tow hitch receiver, said connecting member sized and configured to support said cart on said trailer hitch assembly;
a jack assembly attached to either of said hitch member or said cart bottom, said jack assembly having a jack and a jack base attached to said jack, said jack operatively configured to raise and lower said jack base relative to said cart bottom, said jack base having a plurality of wheels attached thereto, said jack assembly configured to support said cart above a surface and allow movement of said cart on said plurality of wheels across said surface; and
a second tow hitch receiver attached to said cart bottom at or near said second side thereof.

14. The trailer hitch mountable cart according to claim 13, wherein said hitch member is tubular and extends from at or near said first side of said cart bottom to at or near said second side of said cart bottom, said second end of said hitch member defining said second tow hitch receiver.

15. The trailer hitch mountable cart according to claim 13, wherein said cart has one or more wheels rotatably attached thereto.

16. The trailer hitch mountable cart according to claim 13, wherein said plurality of wheels on said jack base are rotatably and pivotally attached to said jack base.

17. The trailer hitch mountable cart according to claim 13, wherein said connecting member is integral with said first end of said hitch member.

18. A trailer hitch mountable cart for use with a vehicle having a trailer hitch assembly with a first tow hitch receiver, said cart comprising:
a cart bottom having a first side, a second side and a bottom surface disposed between said first side and said second side;
a hitch member attached to said cart bottom, said hitch member having a first end and a second end, said first end of said hitch member generally toward said first side of said cart bottom and said second end of said hitch member generally toward said second side of said cart bottom;
a connecting member fixedly attached said first end of said hitch member, said connecting member configured to be received in said first tow hitch receiver so as to interconnect said hitch member to said first tow hitch receiver, said connecting member sized and configured to support said cart on said trailer hitch assembly; and
a jack assembly attached to either of said hitch member or said cart bottom, said jack assembly having a jack and a jack base attached to said jack, said jack operatively configured to raise and lower said jack base relative to said cart bottom, said jack base having a plurality of wheels rotatably and pivotally attached thereto, said jack assembly configured to support said cart above a surface and allow movement of said cart on said plurality of wheels across said surface.

19. The trailer hitch mountable cart according to claim 18, wherein said connecting member is integral with said first end of said hitch member.

20. The trailer hitch mountable cart according to claim 18 further comprising a second tow hitch receiver attached to said cart bottom at or near said second side thereof.

21. A trailer hitch mountable cart for use with a vehicle having a trailer hitch assembly with a first tow hitch receiver, said cart comprising:
a cart bottom having a first side, a second side and a bottom surface disposed between said first side and said second side;
a hitch member attached to said cart bottom, said hitch member having a first end and a second end, said first end of said hitch member generally toward said first side of said cart bottom and said second end of said hitch member generally toward said second side of said cart bottom, said first end of said hitch member defining a receiver tube;
a connecting member sized and configured to interconnect said receiver tube to said first tow hitch receiver and support said cart on said trailer hitch assembly; and
a jack assembly attached to said cart bottom, said jack assembly having a plurality of jacks operatively configured to raise and lower said cart bottom, each of said plurality of jacks having a wheel attached thereto, said jack assembly configured to support said cart above a surface and allow movement of said cart on said wheels across said surface.

22. The trailer hitch mountable cart according to claim 21 further comprising a second tow hitch receiver attached to said cart bottom at or near said second side of said cart bottom.

23. The trailer hitch mountable cart according to claim 21, wherein said hitch member is tubular and extends from at or near said first side of said cart bottom to at or near said second side of said cart bottom, said second end of said hitch member defining a second tow hitch receiver, said second tow hitch receiver sized and configured to receive a hitch bar.
